(19) United States
(12) Patent Application Publication
(10) Pub. No.: US 2025/0376218 A1
(43) Pub. Date: Dec. 11, 2025

(54) LOWER STRUCTURE OF VEHICLE

(71) Applicant: MAZDA MOTOR CORPORATION, Hiroshima (JP)

(72) Inventors: Eiji KAMEMOTO, Hiroshima (JP); Hideyuki TSUKAMOTO, Hiroshima (JP); Hirotaka NATSUME, Hiroshima (JP)

(73) Assignee: MAZDA MOTOR CORPORATION, Hiroshima (JP)

(21) Appl. No.: 19/171,998

(22) Filed: Apr. 7, 2025

(30) Foreign Application Priority Data
Jun. 7, 2024 (JP) 2024-093033

(51) Int. Cl. B62D 25/02; B62D 25/20

(52) U.S. Cl. CPC B62D 25/025; B62D 25/2036

(57) ABSTRACT

Plural cross members extending in a vehicle width direction, a pair of right-and-left side sills positioned at both-side end portions, in the vehicle width direction, of the cross members and having a closed-cross section extending in a vehicle longitudinal direction, respectively, and a reinforcement extending in the vehicle longitudinal direction inside the closed-cross section of each of the pair of side sills and reinforcing the side sill are provided. The reinforcement includes a first area which overlaps, in the vehicle longitudinal direction, the cross members and a second area which is positioned, in the vehicle longitudinal direction, between the cross members, and an inward-side end portion, in the vehicle width direction, of the second area of the reinforcement is positioned on an outward side, in the vehicle width direction of an inward-side end portion, in the vehicle width direction, of the first area of the reinforcement.

### BACKGROUND OF THE INVENTION

The present invention relates to a lower structure of a vehicle.

It has been considered to arrange a reinforcing member inside a side sill as countermeasures for a pole side-collision of a vehicle.

Japanese Patent Laid-Open Publication No. 2021-024350, for example, discloses a vehicle-body structure in which a reinforcing member (reinforcement) having a continuous-cylindrical structure in which plural polygonal-shaped closed-cross sections are continuous when viewed in a vehicle width direction and a deformation-control member to control deformation, in a vehicle longitudinal direction, of the continuous-cylindrical structure of the reinforcing member are arranged inside a side sill extending in a vehicle longitudinal direction.

The vehicle-body structure of the above-described patent document take measures for the pole side-collision of the vehicle by maintaining the cylindrical structure of the reinforcement even in the vehicle side collision. Thereby, it is expected that a collision load can be transmitted to a vehicle-body constituting member extending in the vehicle width direction, such as a cross member.

However, in a case where the pole side-collision occurs at a portion between the plural cross members, if a shape of the reinforcement is maintained, there is a concern that the side sill may come in toward an inside of a cabin together with the reinforcement. Meanwhile, if the reinforcement is configured such that its rigidity is so low that it can be deformed easily, there is another concern that the load may not be properly transmitted to the cross member and the like.

### SUMMARY OF THE INVENTION

The present invention has been devised in view of the above-described matter and an object of the present invention is to provide a lower structure of a vehicle which can properly absorb the collision load, suppressing a situation where the side sill comes in toward the inside of the cabin in the vehicle side collision.

The lower structure of the vehicle of the present invention comprises a pair of right-and-left side sills extending in a vehicle longitudinal direction and having a closed-cross section, plural cross members extending in a vehicle width direction between the pair of side sills and provided to be separated from each other in the vehicle longitudinal direction, and a reinforcement extending in the vehicle longitudinal direction inside the closed-cross section of each of the pair of side sills and reinforcing the side sill, a position, in a vertical direction, of which overlaps the cross members, wherein the reinforcement includes a first area which overlaps, in the vehicle longitudinal direction, the cross members and a second area which is positioned, in the vehicle longitudinal direction, between the cross members, and an inward-side end portion, in the vehicle width direction, of the second area of the reinforcement is positioned on an outward side, in the vehicle width direction, of an inward-side end portion, in the vehicle width direction, of the first area of the reinforcement.

According to the present invention, when the pole-side collision occurs in the first area of the reinforcement, the collision load can be efficiently transmitted to the cross members by the reinforcement. Meanwhile, when the pole-side collision occurs in the second area of the reinforcement, the reinforcement is deformed due to the collision load, so that the reinforcement moves inward, in the vehicle width direction, of a vehicle body. Herein, since the second area of the reinforcement is configured such that its inward-side end portion is relatively positioned on the outward side, even if the reinforcement moves inward, it can be suppressed that the side sill comes in toward the inside of the cabin. Further, the collision load is absorbed in the process of the inward moving of the reinforcement. Accordingly, the lower structure can properly absorb the collision load, suppressing the situation where the side sill comes in toward the inside of the cabin in the vehicle side collision.

In an embodiment of the present invention, a position, in the vehicle width direction, of the inward-side end portion of the second area of the reinforcement changes according to a distance thereof, in the vehicle longitudinal direction, from the cross members such that the larger the distance is, the more outward, in the vehicle width direction, the position of the inward-side end portion of the second area is.

That is, the collision load causes a situation where the farther position from the cross member moves inward more. According to this embodiment, it can be effectively suppressed that the side sill comes in toward the inside of the cabin.

In another embodiment of the present invention, the inward-side end portion of the second area of the reinforcement is of an arch shape in a plan view such that a central portion thereof is recessed outward, in the vehicle width direction, the most.

That is, in a case where no cross member is provided, the inward-side end portion of the reinforcement tends to be deformed in an arc shape such that the collision point protrudes inward the most in the pole-side collision. According to this embodiment, since the inward-side end portion of the reinforcement is recessed in an inverse manner (direction) relative to the above-described deformation state of the reinforcement in the pole-side collision, it can be effectively suppressed that the side sill comes in toward the inside of the cabin.

In another embodiment of the present invention, the inward-side end portion of the first area of the reinforcement is configured to extend in the vehicle longitudinal direction along an outward-side end portion, in the vehicle width direction, of the cross member.

According to this embodiment, when the pole-side collision occurs in the first area, the collision load can be efficiently transmitted to the cross member by the reinforcement. Accordingly, the lower structure can absorb the collision load efficiently.

In another embodiment of the present invention, the reinforcement has plural ridgelines extending in the vehicle width direction.

According to this embodiment, the ridgelines of the reinforcement are compressively deformed, so that the collision load can be absorbed. Thereby, even if the inward-side end portion of the reinforcement is relatively positioned on the outward side like the second area, the collision load can be absorbed sufficiently. Accordingly, the lower structure can properly absorb the collision load, suppressing the situation where the side sill comes in toward the inside of the cabin in the vehicle side collision.

As described above, the lower structure of the vehicle of the present invention can properly absorb the collision load, suppressing the situation where the side sill comes in toward the inside of the cabin in the vehicle side collision.

The present invention will become apparent from the following description which refers to the accompanying drawings.

### BRIEF DESCRIPTION OF THE DRAWINGS

FIG. 1 is a plan view showing a vehicle body of a vehicle equipped with a lower structure according to an exemplified embodiment.

FIG. 2 is a perspective view of a right-side side sill, when viewed from an upper right-rear side.

FIG. 3 is a sectional view taken along lone III-III of FIG. 2.

FIG. 4 is a sectional view taken along lone IV-IV of FIG. 2.

FIG. 5 is a perspective view of a reinforcement.

FIG. 6 is a sectional view taken along lone VI-VI of FIG. 3.

FIG. 7 is a schematic diagram showing a shape of the reinforcement in a VII area of FIG. 2.

FIG. 8A is a diagram showing a movement of a conventional reinforcement in a vehicle side collision, which shows a state before the collision.

FIG. 8B is a diagram showing the movement of the conventional reinforcement in the vehicle side collision, which shows a state after the collision.

FIG. 9A is a diagram showing a movement of a reinforcement of the present embodiment in the vehicle side collision, which shows a state before the collision.

FIG. 9B is a diagram showing the movement of the reinforcement of the present embodiment in the vehicle side collision, which shows a state after the collision.

FIG. 10 is a graph showing a relationship between the coming-in amount of an inward-side end portion, in a vehicle width direction, of the vehicle in a second area and the absorption amount of a collision load.

### DETAILED DESCRIPTION OF THE INVENTION

Hereafter, an exemplified embodiment of the present invention will be described specifically referring to the drawings. In the following description, respective positions (directions) of front, rear, left, right, upper and lower relative to a vehicle 1 will be merely referred to as the “front,” “rear,” “left,” “right,” “upper” and “lower.” A lateral direction corresponds to a vehicle width direction.

### (1) Whole Structure of Lower Portion of Vehicle

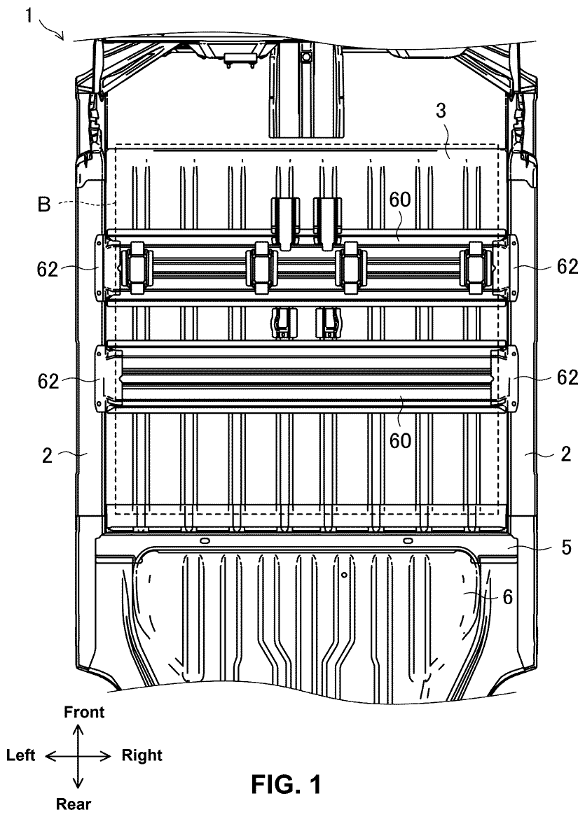

FIG. 1 shows a lower vehicle body of the vehicle 1 provided with a lower structure according to the present embodiment. The vehicle 1 is a four-door type passenger vehicle. In the present embodiment, the vehicle 1 has a laterally-symmetrical vehicle-body structure.

The vehicle 1 comprises a pair of right-and-left side sills 2. Each of the pair of side sills 2 extends straightly in a longitudinal direction. The side sill 2 has a structure having a closed-cross section, and the closed-cross section extends straightly in the longitudinal direction, which will be specifically described later.

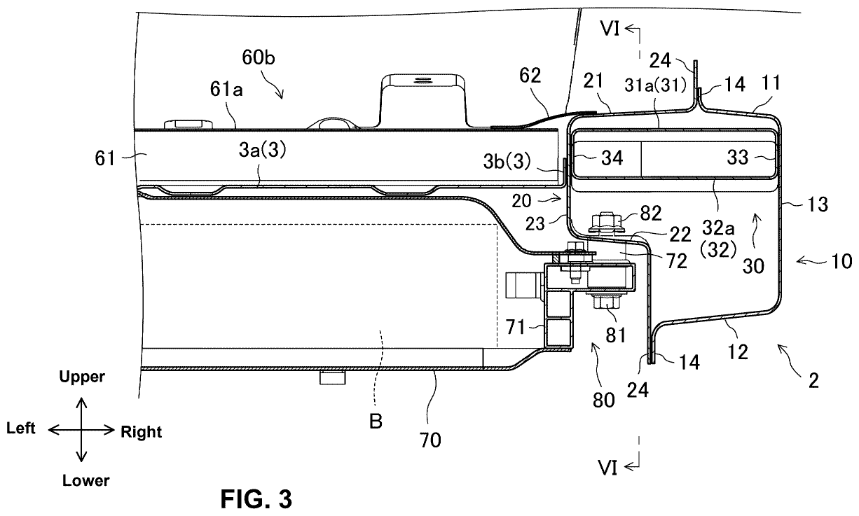

The vehicle 1 comprises a floor panel 3 which forms a floor face of a cabin. The floor panel 3 comprises a floor panel body 3a (see FIGS. 3 and others) which expands in the vehicle width direction and in the longitudinal direction and floor-panel joint portions 3b (see FIGS. 3 and others) which are fixed to the side sills 2 by welding. The left-side floor-panel joint portion 3b is fixedly welded to a right-side portion of the left-side side sill 2. The right-side floor-panel joint portion 3b is fixedly welded to a left-side portion of the right-side side sill 2.

A kick-up portion 5 which rises upward is arranged at a rear end of the floor panel 3. A rear floor panel 6 expands rearward from the kick-up portion 5. The rear floor panel 6 forms a floor face of a luggage room mainly.

Two cross members 60 extending in the lateral direction are arranged above the floor panel 3. The two cross members 60 are aligned such that they are separated from each other in the longitudinal direction. A longitudinal position of the rear-side cross member 60 is the same as that of a center pillar, which is not illustrated. In the flowing description, the cross member 60 positioned on a relatively front side will be referred as a front-side cross member 60a and the cross member 60 positioned on a relatively rear side will be referred to as a rear-side cross member 60b in some cases. When these are not differentiated, the generic name of the cross member 60 will be used.

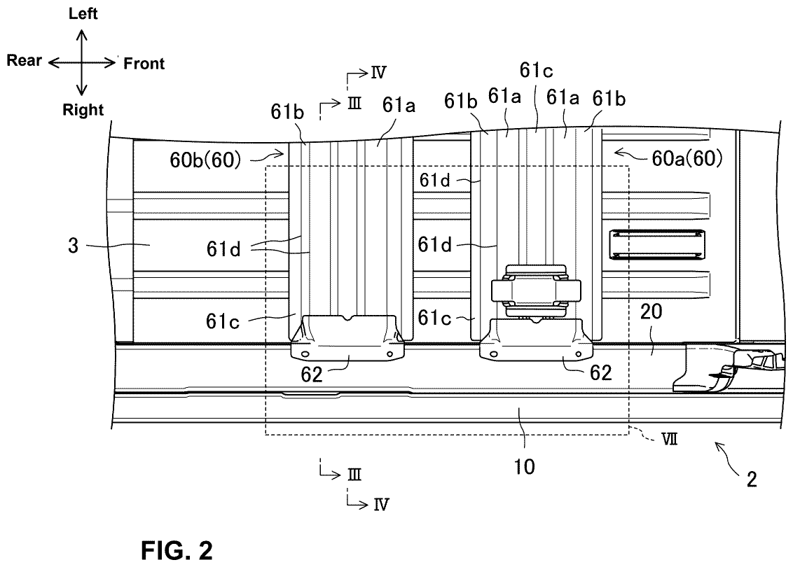

As shown in FIG. 2, the cross member 60 includes a cross-member body 61 and brackets 62. The brackets 62 are fixed to both sides, in the lateral direction, of the cross-member body 61 (the right-side bracket 62 is shown in FIG. 2 only). The left-side bracket 62 is fixed to the left-side side sill 2 by welding, and the right-side bracket 62 is fixed to the right-side side sill 2 by welding. Thereby, the both-side end portions, in the lateral direction, of the cross member 60 are fixed to the side sills 2. A lower end of the cross-member body 61 is fixed to an upper face of the floor panel 3.

The cross-member body 61 has a cross section which is of a M-letter shape. The cross-member body 61 comprises two upper face portions 61a, four side face portions 61b, and a joint face portion 61c which is joined to the floor panel 3. A cross-member ridgeline portion 61d extending in the lateral direction is formed between the upper face portion 61a and the side face portion 61b and also between the joint face portion 61c and the side face portion 61b.

As shown in FIG. 3, a battery B is arranged below the floor panel 3. The battery B is arranged in a state where it is stored in a battery case 70. The battery B is provided in a range which overlaps a roughly whole part of the floor panel 3 in a plan view.

The battery B is supported at lower wall portions (inner lower-wall portions 22 described later) of the side sills 2 together with the battery case 70 via support portions 80. Specifically, a bracket 71 extending outward, in the vehicle width direction, of a vehicle body is fixed to an outward portion, in the vehicle width direction, (to a right-side portion in FIG. 3) of the battery case 70. A bolt 81 is inserted into an outward-side portion, in the vehicle width direction, (into a right-side end portion in FIG. 3) of the bracket 71. The bolt 81 is supposed to engage with a nut 82 which is fixed to a portion inside the closed-cross section of the inner lower-wall portion 22 of the side sill 2. The bolt 81 is inserted into the bracket 71 from below and fixed by the nut 82. Thereby, the battery B is supported at the side sills 2 via the battery case 70 and the brackets 71. The bolt 81 and the nut 82 constitute a support portion 80. A bush 72 is arranged around the bolt 81 between the bracket 71 and the inner lower-wall portion 22. The bush 72 is made of a resilient member.

### (2) Side Sill

Hereafter, a structure of the side sill 2 will be described specifically. As described above, since the vehicle-body structure of the vehicle 1 is laterally symmetrical, the structure of the right-side side sill 2 will be described specifically, and specific description of the left-side side sill 2 is omitted here. Further, in the description of the right-side side sill 2, the right side corresponds to the outward side, in the vehicle width direction, of the vehicle body and the left side corresponds to the inward side, in the vehicle width direction, of the vehicle body.

### (2-1) Outer Panel, Inner Panel

As shown in FIG. 3, the side sill 2 includes an outer panel 10 positioned on the right side relatively and an inner panel 20 positioned on the left side relatively. A material of the outer panel 10 and the inner panel 21 is not limited to a particular one, but iron is applicable, for example.

The outer panel 10 has a hat-shaped cross section which is open to the left side. The outer panel 10 comprises an outer upper-wall portion 11 which expands in the longitudinal direction and in the lateral direction, an outer lower-wall portion 12 which is provided to face the outer upper-wall portion 11 in a vertical direction and expands in the longitudinal direction and in the lateral direction, and an outer side-wall portion 13 which connects, in the vertical direction, a right-side end portion of the outer upper-wall portion 11 and a right-side end portion of the outer lower-wall portion 12 and expands in the vertical direction and in the longitudinal direction. A pair of outer flanges 14 extend in the vertical direction from a left-side end portion of the outer upper-wall portion 11 and a left-side wall portion of the outer lower-wall portion 12, respectively. The outer upper-wall portion 11 is inclined such that it extends obliquely rightward-and-downward. The outer lower-wall portion 12 is inclined such that it extends obliquely rightward-and-upward. The left-side end portion of the outer upper-wall portion 11 is positioned on the right side of the left-side end portion of the outer lower-wall portion 12.

The inner panel 20 has a hat-shaped cross section which is open to the right side. The inner panel 20 comprises an inner upper-wall portion 21 which expands in the longitudinal direction and in the lateral direction, an inner lower-wall portion 22 which is provided to face the inner upper-wall portion 21 in the vertical direction and expands in the longitudinal direction and in the lateral direction, and an inner side-wall portion 23 which connects, in the vertical direction, a left-side end portion of the inner upper-wall portion 21 and a left-side end portion of the inner lower-wall portion 22 and expands in the vertical direction and in the longitudinal direction. A pair of inner flanges 24 extend in the vertical direction from a right-side end portion of the inner upper-wall portion 21 and a right-side wall portion of the inner lower-wall portion 22, respectively. The inner upper-wall portion 21 is inclined such that it extends obliquely leftward-and-downward. The inner lower-wall portion 22 extends straightly in the lateral direction. The inner lower-wall portion 22 has an insertion hole of the bolt 81.

The outer flanges 14 of the outer panel 10 and the inner flanges 24 of the inner panel 20 are provided to overlap each other in a state where their openings face each other in the lateral direction. The outer flanges 14 and the inner flanges 24 are joined by welding. Thereby, the side sill 2 has the structure having the rectangular-shaped closed-cross section which is formed by the outer upper-wall portion 11, the outer lower-wall portion 12, the outer side-wall portion 13, the inner upper-wall portion 21, the inner lower-wall portion 22, and the inner side-wall portion 23.

The floor panel 3 and the cross member 60 are fixed to the inner panel 20. Specifically, as shown in FIG. 3, the floor-panel joint portion 3b of the floor panel 3 is formed by a right-side end portion of the floor panel body 3a which is bent upward, and extends along the inner side-wall portion 23 and is joined to a left-side face of the inner side-wall portion 23. The bracket 62 of the cross member 60 is provided to cover a corner portion between the inner upper-wall portion 21 and the inner side-wall portion 23. The bracket 62 has a portion for welding which extends continuously along the inner upper-wall portion 21. This welding portion is joined to the inner upper-wall portion 21. Herein, FIG. 3 shows a fixation structure of the rear-side cross member 60 and the inner panel 20. The fixation structure of the front- side cross member 60 and the inner panel 20 are the same as the fixation structure of the rear-side cross member 60 and the inner panel 20.

### (2-2) Reinforcement

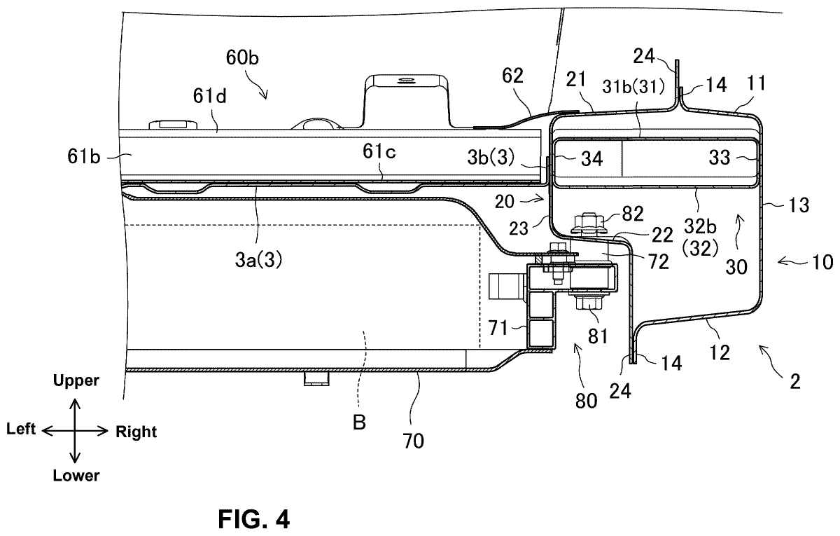

As shown in FIGS. 3 and 4, a reinforcement 30 to reinforce the side sill 2 is arranged inside the closed-cross section of the side sill 2. The reinforcement 30 is formed by pressing of a pipe. The reinforcement 30 extends in the longitudinal direction inside the closed-cross section of the side sill 2. The material strength of the reinforcement 30 is lower than that of the cross-member body 61. Herein, the material strength means the strength of a plate itself which constitutes the member. The material strength is a parameter to be determined by the tensional strength and the thickness of the plate, for example. The higher the tensional strength is, the higher the material strength is. Also, the larger the thickness is, the higher the material strength is. The material of the reinforcement 30 is not limited to a particular one, but it is iron, for example.

The reinforcement 30 is arranged over an entire part of the side sill 2. The reinforcement 30 is seamlessly arranged at a position which corresponds to the cross members 60 and also at an intermediate position between the two cross members 60. The reinforcement 30 is arranged at a position which overlaps the two cross members 60 in the vertical direction.

The reinforcement 30 has a structure having a rectangular-shaped closed-cross section. The reinforcement 30 includes an upper-side lateral wall portion 31 which is positioned at a relatively upper side and expands in the longitudinal direction and in the lateral direction and a lower-side lateral wall portion 32 which is provided to face the upper-side lateral wall portion 31 in the vertical direction and expands in the longitudinal direction and in the lateral direction. The reinforcement 30 includes an outward-side vertical wall portion 33 which is positioned at a relatively right side and expands in the longitudinal direction and in the vertical direction and an inward-side vertical wall portion 34 which is provided to face the outward-side vertical wall portion 33 in the lateral direction and expands in the longitudinal direction and in the vertical direction. The outward-side vertical wall portion 33 connects, in the vertical direction, a right-side end portion of the upper-side lateral wall portion 31 and a right-side end portion of the lower-side lateral wall portion 32. The inward-side vertical wall portion 34 connects, in the vertical direction, a left-side end portion of the upper-side lateral wall portion 31 and a left-side end portion of the lower-side lateral wall portion 32. The upper-side lateral wall portion 31, the lower-side lateral wall portion 32, the outward-side vertical wall portion 33, and the inward-side vertical wall portion 34 are made of a single member and formed integrally seamlessly.

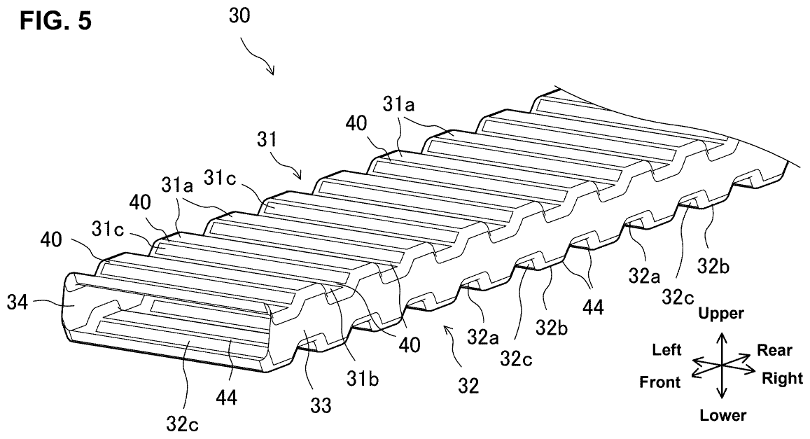

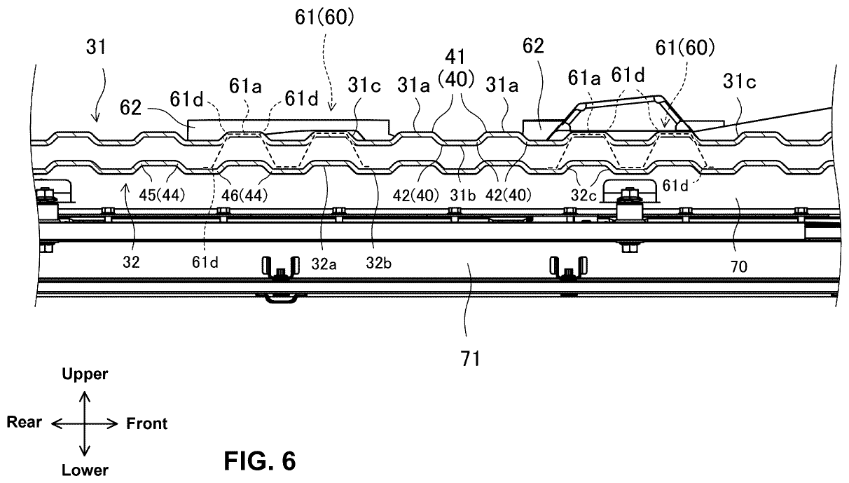

As shown in FIGS. 5 and 6, the upper-side lateral wall portion 31 is of an uneven (concave-and-convex) shape when viewed in the lateral direction. Specifically, the upper-side lateral wall portion 31 comprises a first upper-face portion 31a which is relatively positioned at an upper side and expands in the longitudinal direction and in the lateral direction, a second upper-face portion 31b which is relatively positioned at a lower side and expands in the longitudinal direction and in the lateral direction, and an upper-side connection portion 31c which connects, in the vertical direction, an end portion, in the longitudinal direction, of the first upper-face portion 31a and an end portion, in the longitudinal direction, of the second upper-face portion 31b. The first upper-face portion 31a and the second upper-face portion 31b are aligned in the longitudinal direction alternately. The upper-side connection portion 31c to connect the front-side end portion of the first upper-face portion 31a and the rear-side end portion of the second upper-face portion 31b is inclined such that it expands obliquely forward-and-downward. The upper-side connection portion 31c to connect the rear-side end portion of the first upper-face portion 31a and the front-side end portion of the second upper-face portion 31b is inclined such that it expands obliquely forward-and-upward. The width, in the longitudinal direction, of the first upper-face portion 31a is the same as the width, in the longitudinal direction, of the second upper-face portion 31b. The width, in the longitudinal direction, of the first upper-face portion 31a and the second upper-face portion 31b is narrower than the width, in the longitudinal direction, of the cross member 60 and the minimum of a distance between the front-side cross member 60a and the rear-side cross member 60b. Specifically, the width, in the longitudinal direction, of the first upper-face portion 31a and the second upper-face portion 31b is narrower than a half of the width, in the longitudinal direction, of the cross member 60 and also narrower than a half of the minimum of the distance between the front-side cross member 60a and the rear-side cross member 60b. The length, in the vertical direction, of the upper-side connection portion 31c, i.e., the distance, in the vertical direction, of the first upper-face portion 31a and the second upper-face portion 31b is about ¼ of the distance between the upper-side lateral wall portion 31 and the lower-side lateral wall portion 32.

Upper-side ridgeline portions 40 extending in the lateral direction are formed between the first upper-face portion 31a and the upper-side connection portion 31c and between the second upper-face portion 31b and the upper-side connection portion 31c, respectively. The four upper-side ridgeline portions 40 are formed by one-cycle uneven shape comprising the first upper-face portion 31a, the second upper-face portion 31b, and the upper-side connection portions 31c. The cycle-number of the uneven shape multiplied by four equals the number of the upper-side ridgeline portions 40 which are formed at the upper-side lateral wall portion 31 as a whole.

As shown in FIG. 6, the vertical position of the first upper-face portion 31a is the same as the vertical position of the upper face portion 61a of the cross member 60. Accordingly, the upper-side ridgeline portion 40 has the same vertical position as the upper-side cross-member ridgeline portion 61d. Further, the upper-side ridgeline portion 40 has the same longitudinal position as the upper-side cross-member ridgeline portion 61d.

As shown in FIGS. 5 and 6, the lower-side lateral wall portion 32 is of an uneven (concave-and-convex) shape when viewed in the lateral direction. Specifically, the lower-side lateral wall portion 32 comprises a first lower-face portion 32a which is relatively positioned at an upper side and expands in the longitudinal direction and in the lateral direction, a second lower-face portion 32b which is relatively positioned at a lower side and expands in the longitudinal direction and in the lateral direction, and a lower-side connection portion 32c which connects, in the vertical direction, an end portion, in the longitudinal direction, of the first lower-face portion 32a and an end portion, in the longitudinal direction, of the second lower-face portion 32b. The first lower-face portion 32a and the second lower-face portion 32b are aligned in the longitudinal direction alternately. The lower-side connection portion 32c to connect the front-side end portion of the first lower-face portion 32a and the rear-side end portion of the second lower-face portion 32b is inclined such that it expands obliquely forward-and-downward. The lower-side connection portion 32c to connect the rear-side end portion of the first lower-face portion 32a and the front-side end portion of the second lower-face portion 32b is inclined such that it expands obliquely forward-and-upward. The width, in the longitudinal direction, of the first lower-face portion 32a is the same as the width, in the longitudinal direction, of the second lower-face portion 32b. The width, in the longitudinal direction, of the first lower-face portion 32a and the second lower-face portion 32b is the same as the width, in the longitudinal direction, of the first upper-face portion 31a and the second upper-face portion 31b. The vertical length of the lower-side connection portion 32c, i.e., the distance, in the vertical direction, between the first lower-face portion 32a and the second lower-face portion 32b is the same as the vertical distance between the first upper-face portion 31a and the second upper-face portion 31b.

Lower-side ridgeline portions 44 extending in the lateral direction are formed between the first lower-face portion 32a and the lower-side connection portion 32c and between the second lower-face portion 32b and the lower-side connection portion 32c, respectively. The four lower-side ridgeline portions 44 are formed by one-cycle uneven shape comprising the first lower-face portion 32a, the second lower-face portion 32b, and the lower-side connection portions 32c. The cycle-number of the uneven shape multiplied by four equals the number of the lower-side ridgeline portions 44 which are formed at the lower-side lateral wall portion 32 as a whole.

As shown in FIG. 4, the vertical position of the second lower-face portion 32b is the same as the vertical position of the floor panel body 3a. Accordingly, the vertical position of the lower-side ridgeline 44 is the same as the vertical position of the floor panel body 3a. Further, the vertical position of the second lower-face portion 32b is slightly below the joint face portion 61c of the cross-member body 61. Accordingly, the lower-side ridgeline portion 44 is slightly below the lower-side cross-member ridgeline portion 61d.

As shown in FIG. 6, the longitudinal position of the first upper-face portion 31a is the same as the longitudinal position of the first lower-face portion 32a. The longitudinal position of the second upper-face portion 31b is the same as the longitudinal position of the second lower-face portion 32b. The longitudinal position of the upper-side ridgeline portion 40 is the same as the longitudinal position of the lower-side ridgeline portion 44. Further, the vertical distance between the first upper-face portion 31a and the first lower-face portion 32a, the vertical distance between the second upper-face portion 31b and the second lower-face portion 32b, and the vertical distance between the upper-side connection portion 31c and the lower-side connection portion 32c are the same.

The outward-side vertical wall portion 33 and the inward-side vertical wall portion 34 have the shape corresponding to the uneven shape of the upper-side lateral wall portion 31 and the lower-side lateral wall portion 32.

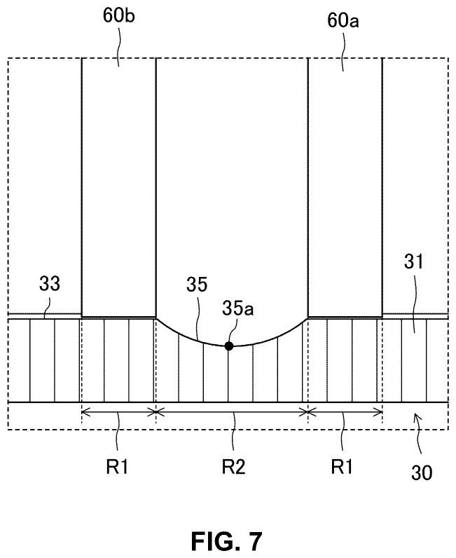

As shown in FIG. 7, the reinforcement 30 is configured such that a portion thereof between the front-side cross member 60a and the rear-side cross member 60b and another portion thereof which corresponds to the front-side cross member 60a and the rear-side cross member 60b have different shapes from each other. Specifically, when an area which overlaps, in the longitudinal direction, the front-side cross member 60a or the rear-side cross member 60b is defined as a first area R1, and another area which is positioned, in the longitudinal direction, between the front-side cross member 60a and the rear-side cross member 60b is defined as a second area R2, a left-side end portion of the second area R2 is positioned on the outward side, in the vehicle width direction, of a left-side end portion of the first area R1. Specifically, at the second area R2, the left-side end portion of the reinforcement 30 has an arch-shaped rightward recess portion 35. Herein, a position, in the vehicle width direction, of the left-side end portion of the inward-side recess portion 35 changes according to a distance thereof, in the vehicle longitudinal direction, from the cross members 60 such that the larger said distance is, the more rightward the above-described position of the left-side end portion of the inward-side recess portion 35 is. Meanwhile, at the first area R1, the left-side end portion of the reinforcement 30 extends in the longitudinal direction along the right-side end portion of the cross member 60.

The inward-side recess portion 35 has an apex portion 35a which is located at a central position, in the longitudinal direction, of the second area R2 and at the rightmost position in the vehicle width direction. The shape of the inward-side recess portion 35 is longitudinally symmetrical relative to the apex portion 35a. The depth of the apex portion 35a of the inward-side recess portion 35 from the left-side end portion of the reinforcement 30 is less than 1/2 of the width, in the lateral direction, of the other portion of the reinforcement 30 than the inward-side recess portion 35. At the inward-side recess portion 35, the left-side end portion of the upper-side lateral wall portion 31 and the left-side end portion of the lower-side lateral wall portion 32 are configured to be cutout toward the right side. At the inward-side recess portion 35, the inward vertical wall portion 34 is configured to be curved in the arch shape toward the right side. At the inward-side recess portion 35, the inward vertical wall portion 34 is separated, in the lateral direction, from the floor panel 3. Herein, in FIG. 7, the lower-side lateral wall portion 32 is not viewed because of its overlapping the upper-side lateral wall portion 31.

At the second area R2, the right-side end portion of the upper-side lateral wall portion 31, the right-side end portion of the lower-side lateral wall portion 32, and the outward-side vertical wall portion 33 are located at the same position in the lateral direction. At the second area R2, the right-side end portion of the upper-side lateral wall portion 31, the right-side end portion of the lower-side lateral wall portion 32, and the outward-side vertical wall portion 33 are located at the same position, in the lateral direction, as the right-side end portion of the upper-side lateral wall portion 31, the right-side end portion of the lower-side lateral wall portion 32, and the outward-side vertical wall portion 33 at the first area R1. That is, the right-side end portion of the reinforcement 30 has the same position, in the lateral direction, of the vehicle body both at the first area R1 and the second area R2.

The upper-side ridgeline portion 40 and the lower-side ridgeline portion 44 at the second area R2 is shorter than these portions 40, 44 at the first area R1. Herein, in FIG. 7, the lower-side ridgeline portion 44 is not viewed because of its overlapping the upper-side lateral wall portion 31.

In the present embodiment, each of a portion of the reinforcement 30 which is positioned on the forward side of the front-side cross member 60a and another portion of the reinforcement 30 which is positioned on the rearward side of the rear-side cross member 60b is configured such that its both-side end portions have the same positions in the vehicle width direction, which is similar to the area R1.

The outward-side vertical wall portion 33 is fixed to the outer side-wall portion 13 and the inward-side vertical wall portion 34 is fixed to the inner side-wall portion 23, whereby the reinforcement 30 is fixed to the side sill 2. The inward-side vertical wall portion 34 is separated from the inner side-wall portion 23 at the inward-side recess portion 35, and is not fixed to the inner side-wall portion 23. A fixation method of the outward-side vertical wall portion 33 and the outer side-wall portion 13 and a fixation method of the inward-side vertical wall portion 34 and the inner side-wall portion 23 are not limited to a particular one, but welding, adhesion by an adhesive agent, bolt fastening or the like are applicable, for example.

An area of the closed-cross section which is formed by the upper-side lateral wall portion 31, the lower-side lateral wall portion 32, the outward-side vertical wall portion 33, and the inward-side vertical wall portion 34 does not change in the longitudinal direction.

### (3) Movement in Vehicle Side Collision

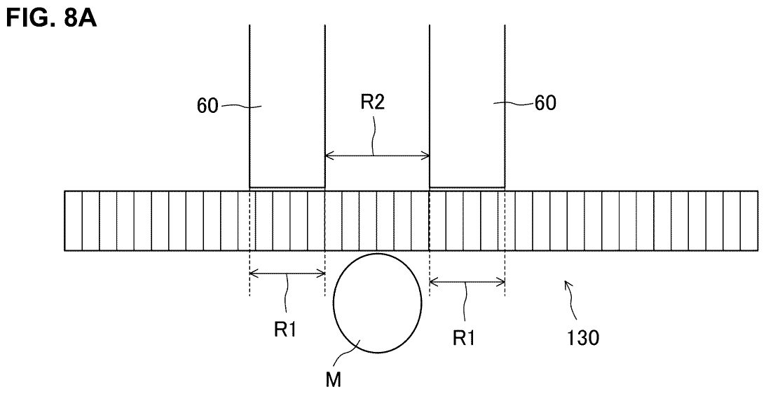

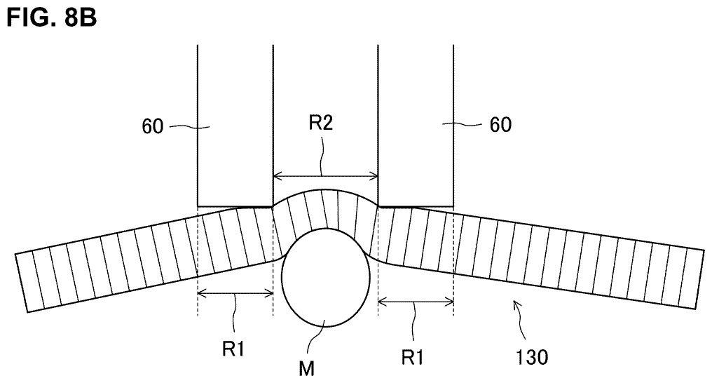

FIGS. 8A and 8B show a deformation movement of a conventional reinforcement 130 in the pole-side collision in a case where respective positions, in the lateral direction, of respective left-side end portions of a first area R1 and a second area R2 of the reinforcement 130. FIG. 8A shows a state before the collision and FIG. 8B shows a state after the collision.

It is assumed here that the pole-side collision of the object M occurs at a portion of the second area R2 of the reinforcement 130. The longitudinal position of the collision point is a central position of the second area R2.

As shown in FIG. 8B, it is suppressed by the cross member 60 that a portion of the first area R1 of the reinforcement 130 comes in toward the inside of the cabin. Also, a front-side portion or a rear-side portion of the reinforcement 130 which is positioned on the forward side or the rearward side of the second area R2 are deformed toward the right side. Accordingly, it is suppressed that the other portion of the reinforcement 130 than the second area R2 moves in toward the inside of the cabin.

Meanwhile, the second area R2 of the reinforcement 130 moves in toward the inside of the cabin due to the collision load. In particular, since a reaction force is hardly applied to the second area R2, the left-side end portion of the reinforcement 130 is deformed toward the inside of the cabin, so that this deformed portion is pushed into the cabin. The side sill 2 is pushed into the cabin together with the reinforcement 130. Accordingly, the side sill 2 comes into the cabin as well. This may cause the cabin inside area to be narrowed. Moreover, there is a concern that the battery case 70 and the battery B may be broken due to the collision load transmitted thereto.

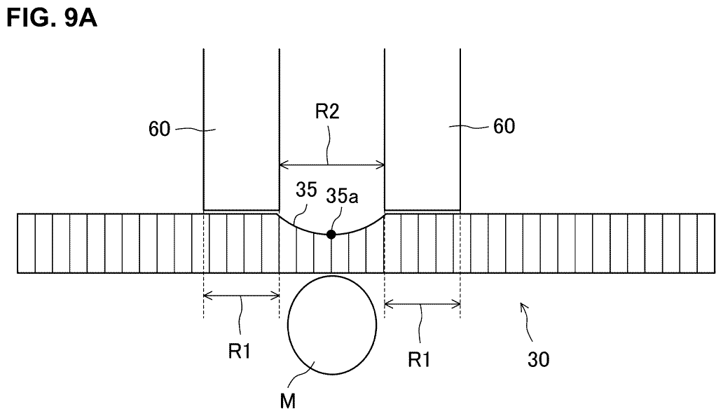

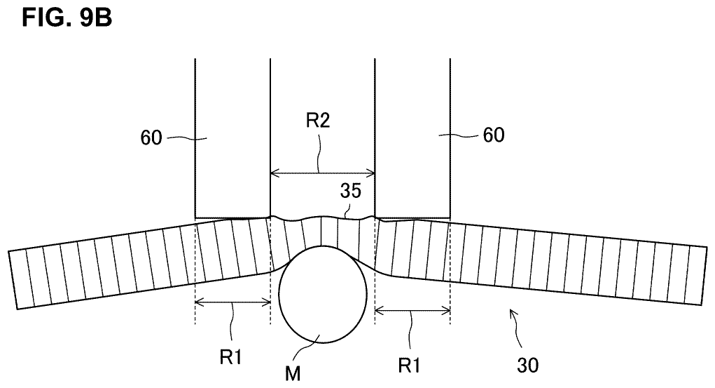

FIGS. 9A and 9B show a deformation movement of the reinforcement 30 of the present embodiment in the pole-side collision. FIG. 9A shows a state before the collision and FIG. 9B shows a state after the collision.

As shown in FIG. 9A, it is assumed that the collision object M has the pole-side collision at a portion of the second area R2 of the reinforcement 30. Herein, the longitudinal position of the collision point is the central position between the front-side cross member 60a and the rear-side cross member 60b.

As shown in FIG. 9B, since the portion of the first area R1 of the reinforcement 30 does not have the inward-side recess portion 35 and its left-side end portion has the uniform position in the lateral direction, the coming-in toward the inside of the first area R1 is suppressed by the cross member 60. Further, the front-side portion or the rear-side portion of the reinforcement 30 which is positioned on the forward side or the rearward side of the second area R2 are deformed toward the right side by the reaction force from the cross member 60. Accordingly, it is suppressed that the other portion of the reinforcement 30 than the second area R2 comes in toward the inside of the cabin.

The portion of the second area R2 of the reinforcement 30 moves toward the inside of the cabin due to the collision load. In the present embodiment, since the inward-side recess portion 35 is formed at the second area R2, it is suppressed that the reinforcement 30 comes in toward the inside of the cabin. Specifically, the inward-side recess portion 35 is deformed by the collision load such that it protrudes toward the inside of the cabin. Since the inward-side recess portion 35 is recessed to the right in the state before the collision, the left-side end portion of the reinforcement 30 may hardly come in toward the inside of the cabin even if the deformation of the inward-side recess portion 35 occurs. Accordingly, the structure of the present embodiment can absorb the collision load, suppressing the situation where the side sill 2 comes in toward the inside of the cabin.

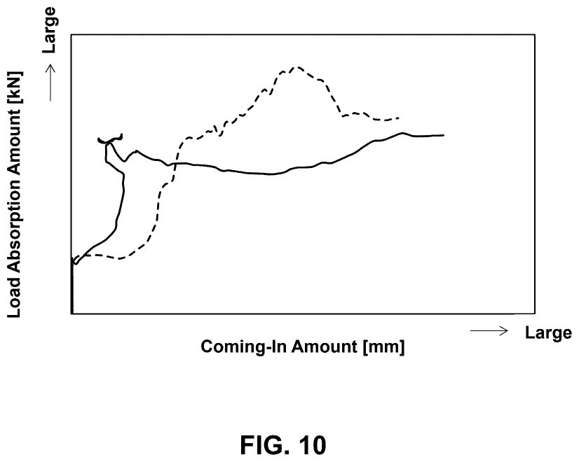

FIG. 10 shows calculation results of a simulation of the coming-in amount of the side sill 2 and the collision load which can be absorbed by this coming-in amount in the pole-side collision against the portion of the second area R2. A broken line shows a case of the reinforcement 130 without the inward-side recess portion 35 shown in FIGS. 8A and 8B, and a solid line shows the present embodiment's case of the reinforcement 30 with the inward-side recess portion 35 shown in FIGS. 9A and 9B. Herein, the simulation was conducted based on a condition where the floor panel 3 does not exist.

As shown in FIG. 10, it is found that in a case where the inward-side recess portion 35 does not exist, the collision load is absorbed first and then the coming-in amount increases without increasing of its absorption amount, and subsequently the absorption amount of the collision load increases as the coming-in amount increases. This is because the reinforcement 130 moves in toward the inside of the cabin without the deformation of the reinforcement 130, and then the reinforcement 130 is compressively deformed, so that the collision load is absorbed.

Meanwhile, it is found that in a case where the inward-side recess portion 35 exists, the collision load is absorbed first and then the absorption amount of the collision load increases with little increase of the coming-in amount of the side sill 2, and subsequently the coming-in amount increases with little increase of the absorption amount of the collision load. This is because the inward-side recess portion 35 exists, so that the collision load can be absorbed by the deformation of the reinforcement 30 without any contact of the reinforcement 30 with the inner panel 20 of the side sill 2. Herein, in a case where the inward-side recess portion 35 exists, since the width, in the lateral direction, of the second area R2 of the reinforcement 30 decreases, the maximum of the load which can be absorbed by the side sill 2 itself becomes smaller than the case where the inward-side recess portion 35 does not exist. However, in the case where the reinforcement 30 becomes the state shown in FIG. 9B, the collision load is absorbed sufficiently, so that the rest of the load can be properly received at the floor panel 3 and the like. In particular, since the relatively-large load is absorbed by the reinforcement 30, the floor panel 3 is hardly deformed even if the rest of the collision load is received at the floor panel 3. Accordingly, even if the gross absorption amount of the collision load by means of the side sill 2 becomes small, there is no problem in particular.

### (4) Effects of Embodiment

In the present embodiment, the reinforcement 30 arranged inside the side sill 2 includes the first area R1 which overlaps, in the vehicle longitudinal direction, the cross members 6 and the second area R2 which is positioned, in the vehicle longitudinal direction, between the cross members 60, and the inward-side end portion, in the vehicle width direction, of the second area R2 of the reinforcement 30 is positioned on the outward side, in the vehicle width direction, of the inward-side end portion, in the vehicle width direction, of the first area R1 of the reinforcement 30. Herein, when the pole-side collision occurs in the first area R1 of the reinforcement 30, the collision load can be efficiently transmitted to the cross members 60 by the reinforcement 30. Meanwhile, when the pole-side collision occurs in the second area R2 of the reinforcement 30, the reinforcement 30 is deformed due to the collision load, so that the reinforcement 30 moves inward, in the vehicle width direction, of the vehicle body. Herein, since the second area R2 of the reinforcement 30 is configured such that its inward-side end portion is relatively positioned on the outward side, even if the reinforcement 30 moves inward, it can be suppressed that the side sill 2 comes in toward the inside of the cabin. Further, the collision load is absorbed in the process of the inward moving of the reinforcement 30. Accordingly, the present embodiment can properly absorb the collision load, suppressing the situation where the side sill 2 comes in toward the inside of the cabin in the vehicle side collision.

In particular, in the present embodiment, the battery case 70 storing the battery B is arranged below the floor panel 3. Since it is suppressed that the side sill 2 moves in toward the inside of the cabin, any breakage of the battery case 70 and the battery B can be suppressed.

Further, in the present embodiment, the respective outward-side end portions of the first and second areas R1, R2 have the same positions, in the vehicle width direction, thereof. Accordingly, it is unnecessary to make the width, in the vehicle width direction, of the side sill 2 large. The present embodiment can effectively absorb the collision load, suppressing the weight increase of the vehicle 1.

In the present embodiment, the position, in the vehicle width direction, of the inward-side end portion of the second area R2 of the reinforcement 30 changes according to the distance thereof, in the vehicle longitudinal direction, from the cross members 30 such that the larger the distance is, the more outward, in the vehicle width direction, the position of the inward-side end portion of the second area R2 is. Accordingly, it can be effectively suppressed that the side sill comes in toward the inside of the cabin.

In the present embodiment, the inward-side end portion of the second area R2 of the reinforcement 30 is of the arch shape in the plan view such that the central portion thereof is recessed outward, in the vehicle width direction, the most. That is, in a case where the cross member 60 is not provided, the inward-side end portion of the reinforcement 30 tends to be deformed in the arc shape such that the collision point protrudes inward the most in the pole-side collision. According to the present embodiment, since the inward-side end portion of the reinforcement 30 is recessed in an inverse manner (direction) relative to the above-described deformation state of the reinforcement 30 in the pole-side collision, it can be effectively suppressed that the side sill 2 comes in toward the inside of the cabin.

In the present embodiment, the inward-side end portion of the first area R1 of the reinforcement 30 is configured to extend in the vehicle longitudinal direction along the outward-side end portion, in the vehicle width direction, of the cross member 30. When the pole-side collision occurs in the first area R1, the collision load can be efficiently transmitted to the cross member 60 by the reinforcement 30. Accordingly, the present embodiment can absorb the collision load efficiently.

In the present embodiment, the reinforcement 30 has the plural upper-side and lower-side ridgelines 40, 44 extending in the vehicle width direction. In the pole-side collision, these ridgelines 40, 44 are compressively deformed, so that the collision load can be absorbed. Thereby, even if the inward-side end portion of the reinforcement 30 is relatively positioned on the outward side like the second area R2, the collision load can be absorbed sufficiently. Accordingly, the present embodiment can properly absorb the collision load, suppressing the situation where the side sill 2 comes in toward the inside of the cabin in the vehicle side collision.

### Other Embodiments

The present invention is not limited to the above-described embodiment, and any modifications are applicable within a scope of the claims.

Each position, in the vehicle width direction, of the respective inward-side end portions of the portion of the reinforcement 30 which is positioned on the forward side of the front-side cross member 60a and the other portion of the reinforcement 30 which is positioned on the rearward side of the rear-side cross member 60b is the same as the position of the inward-side end portion of the first area R1 in the above-described embodiment. However, the above-described position may be located on the outward side compared to the first area R1. In this case, each position, in the vehicle width direction, of the respective inward-side end portions of the front-side portion of the reinforcement 30 which is positioned on the forward side of the front-side cross member 60a and the rear-side portion of the reinforcement 30 which is positioned on the rearward side of the rear-side cross member 60b may be preferably configured to change according to the distance from the front-side cross member 60a and the distance from the rear-side cross member 60b such that the larger the distance is, the more outward, in the vehicle width direction, the position of the inward-side end portion is.

The inward-side recess portion 35 of the above-described embodiment has the arch shape such that its central portion is recessed outward, in the vehicle width direction, the most. However, the inward-side recess portion 35 may be configured such that the position, in the vehicle width direction, of its inward-side end portion does not change regardless of the distance from the cross members 60. Alternatively, a V-letter shape may be applied in place of the above-described arch shape.

The above-described embodiments merely exemplify the lower structure of the vehicle according to the present invention, and therefore the present invention is not limited by these embodiments. Any modifications which are specified in the claims and also construed under the doctrine of equivalents should be within the scope of the present invention.

The present invention described above is useful as the lower structure of the vehicle.

What is claimed is:

1. A lower structure of a vehicle, comprising:
a pair of right-and-left side sills extending in a vehicle longitudinal direction and having a closed-cross section;
plural cross members extending in a vehicle width direction between the pair of side sills and provided to be separated from each other in the vehicle longitudinal direction; and
a reinforcement extending in the vehicle longitudinal direction inside the closed-cross section of each of the pair of side sills and reinforcing the side sill, a position, in a vertical direction, of which overlaps said cross members,
wherein said reinforcement includes a first area which overlaps, in the vehicle longitudinal direction, said cross members and a second area which is positioned, in the vehicle longitudinal direction, between the cross members, and an inward-side end portion, in the vehicle width direction, of said second area of the reinforcement is positioned on an outward side, in the vehicle width direction, of an inward-side end portion, in the vehicle width direction, of said first area of the reinforcement.

2. The lower structure of the vehicle of claim 1, wherein a position, in the vehicle width direction, of said inward-side end portion of the second area of the reinforcement changes according to a distance thereof, in the vehicle longitudinal direction, from said cross members such that the larger said distance is, the more outward, in the vehicle width direction, said position of the inward-side end portion of the second area is.

3. The lower structure of the vehicle of claim 2, wherein said inward-side end portion of the second area of the reinforcement is of an arch shape in a plan view such that a central portion thereof is recessed outward, in the vehicle width direction, the most.

4. The lower structure of the vehicle of claim 1, wherein said inward-side end portion of the first area of the reinforcement is configured to extend in the vehicle longitudinal direction along an outward-side end portion, in the vehicle width direction, of said cross member.

5. The lower structure of the vehicle of claim 1, wherein said reinforcement has plural ridgelines extending in the vehicle width direction.

6. The lower structure of the vehicle of claim 2, wherein said reinforcement has plural ridgelines extending in the vehicle width direction.

7. The lower structure of the vehicle of claim 3, wherein said reinforcement has plural ridgelines extending in the vehicle width direction.

8. The lower structure of the vehicle of claim 4, wherein said reinforcement has plural ridgelines extending in the vehicle width direction.
